(19) United States
(12) Patent Application Publication
(10) Pub. No.: US 2008/0263453 A1
(43) Pub. Date: Oct. 23, 2008

(54) METHOD AND APPARATUS FOR PROCESS CONFIGURATION

(76) Inventors: VIJAY KUMAR AGGARWAL, Austin, TX (US); Srinivas Chowdhury, Temple, TX (US); Scott Stephen Dickerson, Austin, TX (US); Adam Reudeau Holley, Austin, TX (US); Arnaud Airy Mathieu, Austin, TX (US); Chakkalamattam Jos Paul, Austin, TX (US); Puthukode G. Ramachandran, Austin, TX (US)

Correspondence Address: IBM CORP (YA);C/O YEE & ASSOCIATES PC, P.O. BOX 802333, DALLAS, TX, 75380, US

(21) Appl. No.: 11/737,796

(22) Filed: Apr. 20, 2007

(51) Int. Cl. G06F 15/177

(52) U.S. Cl. 715/735

(57) ABSTRACT

A computer implemented method, apparatus, and computer-usable program product for process configuration are provided in the illustrative embodiments. A process that is to be configured is identified. A list of tasks associated with the identified process is displayed. A set of the tasks displayed in the task list are selected. The selected tasks are configured according to one or more task parameters. If the process that is being configured is already running, the process is suspended before the selected tasks are configured. If the process is suspended, the process is resumed after the selected tasks have been configured. The process is identified, the list of task is displayed, and the one or more tasks are selected and configured using a graphical user interface.

### BACKGROUND OF THE INVENTION

1. Field of the Invention

The present invention relates generally to an improved data processing system, and in particular, to a computer implemented method and apparatus for process configuration. Still more particularly, the present invention relates to a computer implemented method, apparatus, and computer-usable program code for configuring a workflow process in an interactive manner.

2. Description of the Related Art

A workflow is a flow of work items. The flow is a series, including one or more work items that may be movement of things or performance of specific tasks. Alternatively, workflow is called a workflow process, or simply, process. Tasks in a process are arranged in some logical order to achieve the goal of the workflow. Thus, a process may include one or more tasks organized in some logical order to achieve a goal.

A process can be planned in advance. A process may include tasks that are delegated to one or more persons and systems. For example, some tasks may be performed by persons, and some tasks may be performed by computer systems, software applications, and other devices. As the process progresses, changes may be required in the process to accommodate changed circumstances.

### SUMMARY OF THE INVENTION

The illustrative embodiments provide a computer implemented method, apparatus, and computer-usable program product for process configuration. A process that is to be configured is identified using a graphical user interface. A list of tasks associated with the identified process is displayed using the graphical user interface. A set of the tasks displayed in the task list are selected using the graphical user interface. The selected tasks are configured according to one or more task parameters using the graphical user interface. If the process that is being configured is already running, the process is suspended before the selected tasks are configured. If the process is suspended, the process is resumed after the selected tasks have been configured.

### BRIEF DESCRIPTION OF THE DRAWINGS

The novel features believed characteristic of the invention are set forth in the appended claims. The invention itself however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which illustrative embodiments may be implemented;

FIG. 3 is a block diagram of a system for process configuration in accordance with an illustrative embodiment;

FIG. 4 is a block diagram depicting an exemplary structure of a process in accordance with an illustrative embodiment;

FIG. 5 is a block diagram depicting an organization of process code in accordance with an illustrative embodiment;

FIG. 6 is a graphical user interface for process selection in accordance with an illustrative embodiment;

FIG. 7 is a graphical user interface for configuring tasks in accordance with an illustrative embodiment;

FIG. 8 is a graphical user interface for further configuring tasks in accordance with an illustrative embodiment;

FIG. 9 is a flowchart depicting steps of configuring a process in accordance with an illustrative embodiment; and

FIG. 10 is a flowchart depicting the steps of performing tasks in accordance with an illustrative embodiment.

### DETAILED DESCRIPTION OF THE PREFERRED EMBODIMENT

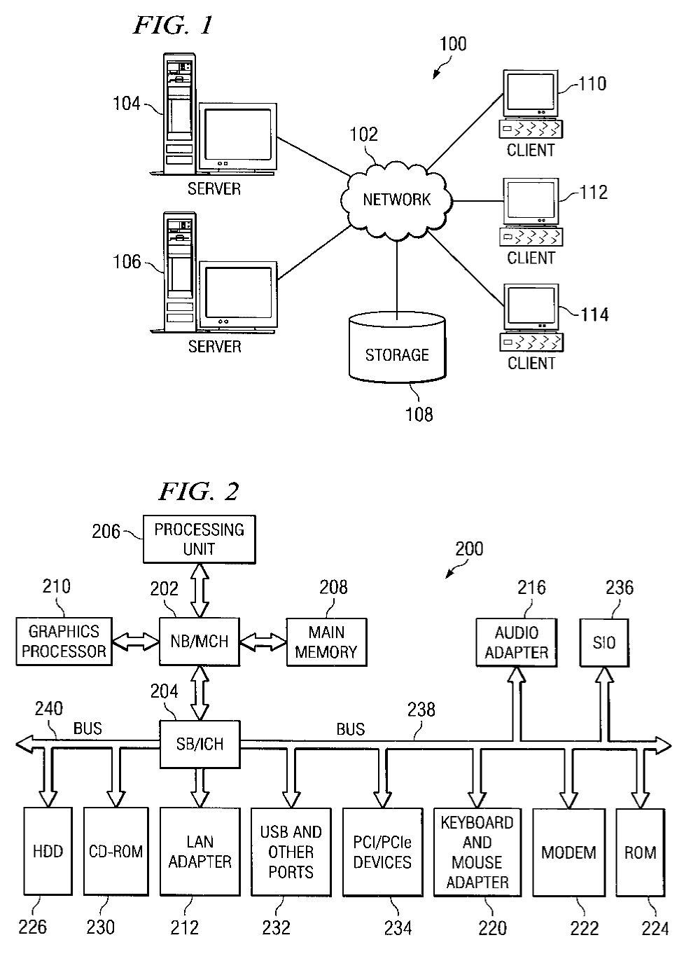

With reference now to the figures and in particular with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub (SB/ICH) 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206, coordinates, and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

A process can be viewed as including one or more activities and an activity as including one or more tasks. In some processes, tasks may be logically grouped together according to activities occurring in the process. For example, an activity may be a group of tasks that may have to be completed before the next group of tasks can be started.

Activities identified in this manner may be a real identifiable activity or a conceptual part of a process. For example, a real identifiable activity is creating a software build. A software build is the conversion of source code of a computer program into executable code. A simple software build may involve compiling a single source code file into an executable code. A complex software build may involve orchestrating hundreds of versions of thousands of files with millions of lines of source code such that a correct executable code results from the compilation.

Creating a software build is a specific identifiable activity in a software deployment and involves several tasks, such as collecting program code files, fixing code versions, compiling the program code, debugging the compiled code, testing, and creating the installation scripts. Other examples and variations of this example are conceivable as specific identifiable activities in a process.

On the other hand, a group of tasks may be grouped together simply on some conceptual basis. For example, a conceptual activity may be a group of tasks to be performed by the same person. For example, a person may be responsible for receiving items into inventory, verifying received items against an order, and approving payment. Such conceptual activities may be further meaningful if another task depends on completion of a group of tasks. In such cases, the group of tasks on which another task depends can be conceptualized as an activity in a process. Other ways of creating identifiable activities as well as conceptual activities are conceivable from these examples.

Software applications for process planning and configuration generally involve the process being encoded into some programming language code. Such encoding of the process into a programming language code is called a process code. A technology called business process execution language (BPEL) is an example of a programming language that may be used for fixing the process code. Business process execution language is a programming language and includes features of extensible markup language (XML). Business process execution language is used for modeling business processes. A business process is a process including one or more tasks, geared to achieve a business goal.

A process, and the tasks within the process, can be configured in process code, such as, for example, by using business process execution language. For example, using the structure provided by this programming language, a user, such as a software developer, can create tasks, assign the tasks to certain persons or systems, and define parameters for the tasks. In configuring BPEL tasks in this exemplary manner, the user can define parameters, such as the order in which the tasks are to be performed, date and time at which the tasks are to be performed, how the results are to be returned to the process, and how the process moves forward to the next task. Several other parameters are conceivable for implementation-specific tasks in a given process.

As the process progresses, changes may be required in the process to accommodate changed circumstances. For example, presently, a process that is configured in BPEL has to be reprogrammed in BPEL to make any changes. BPEL programming can be involved and complicated and often requires the support of a software developer. Often, a process has to be configured, managed, and modified by persons other than software developers after the initial BPEL process has been created.

The different embodiments recognize that when a need arises for configuring a process in a manner different from the configuration of that process in the process code, the configuration can be time consuming, inefficient, and inflexible. Consequently, the different embodiments provide a computer implemented method, apparatus, and computer program product for configuring processes encoded in process code in a more user-friendly way is desirable.

The different embodiments provide a graphical user interface based computer implemented method, apparatus, and computer program product for manipulating the configuration of processes. Using the different embodiments, persons who may not be software developers can configure, manage, and modify a process without having to manually modify the underlying process code. The different embodiments perform the modification of the underlying process code to implement the modified process configuration based on the manipulations on the graphical user interface.

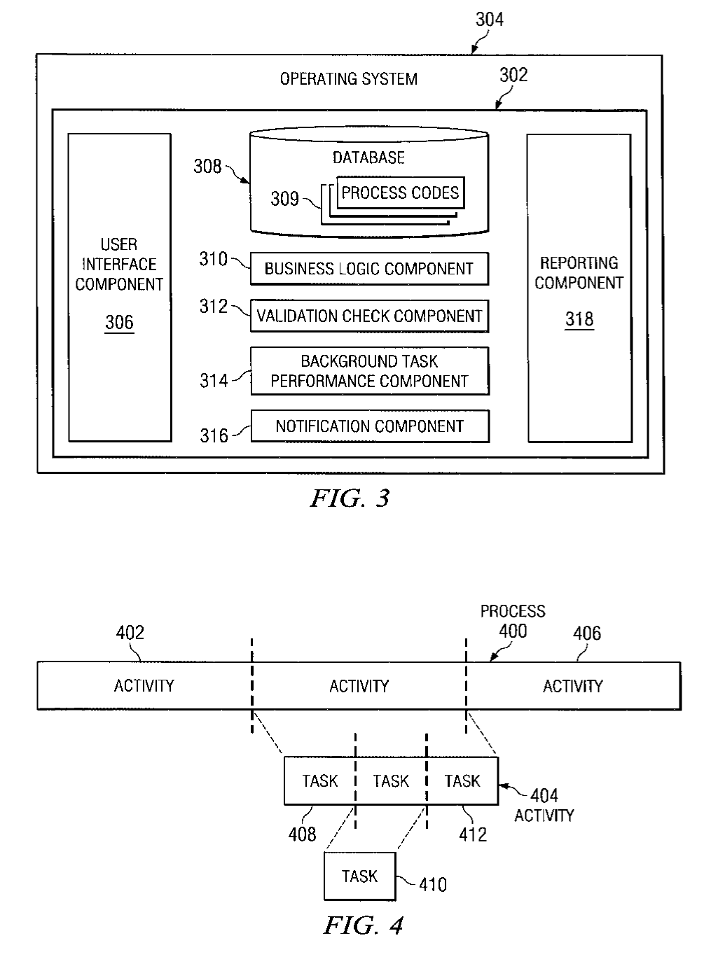

With reference now to FIG. 3, a block diagram of a system for process configuration is depicted in accordance with an illustrative embodiment. System 302 can be implemented in a server, such as server 104 in FIG. 1 or a client, such as client 114 in FIG. 1. Furthermore, system 302 can be used for configuring a process, such as process 400 in FIG. 4.

As depicted, system 302 includes several components that may be implemented in hardware, software, or a combination thereof. Furthermore, the components of system 302 operate under operating system 304, including but not limited to, an operating system described with respect to FIGS. 1 and 2 above.

System 302 includes user interface component 306, which presents a graphical user interface to a user, such as a manager or a person responsible for managing a process. The graphical user interface includes a graphical display of the process that the user may want to configure. The detailed description of FIGS. 6-8 below describe exemplary graphical user interface that may be used in this manner.

System 302 further includes database 308 that may be used for storing the details of a configured process, parameters of specific tasks, and other information relevant to a process and process configuration. Database 308 may be, for example, a flat-file, a spreadsheet, a relational or object-oriented database, or any other data storage mechanism suitable for use in this manner. In the depicted system 302, database 308 is shown to contain a set of process codes 309. A set of process codes is one or more process codes containing the encoded configurations of their respective processes.

Business logic component 310 includes rules, constraints, and factors to be considered in configuring a process. Rules, constraints, and factors for configuring a process are logical computations about the configuration of the process. For example, a rule may be that a software release date cannot be sooner than a software build date. An exemplary constraint may be that a software build activity is not completed until an approval task in the software build activity has completed. A software build activity is an activity in a process, the activity involving creating a software build as described earlier. An exemplary factor in configuring a process may be a holiday schedule that should be considered when scheduling tooling or personnel.

Many other rules, constraints, and factors are implementation dependent. Rules, constraints, and factors are only different characterizations of business logic and are not intended to be rigid classifications limiting on the illustrative embodiments. For example, a policy can be implemented as a rule, a constraint, or a factor as described above or as a separate category called policy in a specific implementation. Business logic component 310 can be implemented in software, hardware, or a combination thereof. Furthermore, portions of business logic component 510 may be stored in database 308.

Validation check component 312 applies the rules, constraints, and other factors included in business logic component 310 to a process configuration. For example, during configuring an exemplary software deployment process, a manager may accidentally omit an approval step in the software build activity. Validation check component 312 performs an analysis on the process as configured. In specific implementations, the analysis may be performed to identify any conflicts amongst tasks, violation of rules, and other similar characteristics of a process as configured. As another example, a first task may have been configured to start after the second task, and the second task may have been configured to start after the first task, creating a circular dependency. A circular dependency created in this manner is an error because this error will prevent the first task and the second task from starting if the process is executed in this form.

As described above, tasks in a process may or may not require actions by persons. Some tasks may be performed by systems and applications, and other tasks may require participation of a person. Background task performance component 314 performs those tasks that can be automatically performed. Functionality of background task performance component 314 may include identifying automatic tasks, performing those tasks, and reporting the results of those tasks into the process. Additional functions may be performed, or functions may be combined or omitted in background task performance component 314 in specific implementation of the illustrative embodiments.

When a task in a process requires notifying a person, notification component 316 performs the notification function. For example, a notification may be sent to a person who is responsible for a task that is expected to start after a currently running task completes.

Reporting component 318 gathers reports on tasks as they are performed in a process. For example, a task may report data at various times during the task's execution that reporting component 318 may collect. As another example, a person may report the completion of the task assigned to the person. Reporting component 318 also gathers such reported information. Other types of information may be reported at task level or process level by systems and persons, depending on specific implementation of the illustrative embodiments.

Reporting component 318 can also generate reports relevant to a process. For example, a periodic status report may be generated for a process whose status must be tracked. As another example, an error report may be generated when an error condition is encountered in performing a task. Many other reports will be generated to fit specific implementations. For example, reporting component 318 may send a status report to notification component 316 for communication to a manager of a process. Furthermore, the various reporting functions described above are only exemplary and not intended to be limiting on the illustrative embodiments. Reporting functions may be combined, removed, or implemented differently in implementation-specific ways without departing from the spirit of the illustrative embodiments.

Note that the various components of system 302 provide a user with a way to re-configure a process without re-coding the process code, such as BPEL code, that contains the details of the process. The various components of system 302 translate the user interactions with those components into suitable process code to reconfigure the process as desired by the user.

With reference now to FIG. 4, a block diagram depicting an exemplary structure of a process is shown in accordance with an illustrative embodiment. The depicted process can be coded in BPEL and implemented in a data processing system, such as server 104 or client 114 in FIG. 1. Furthermore, the process code, such as a process code in the set of process codes 309 in FIG. 3, can be stored in a database, such as database 308 in FIG. 3. Furthermore, the process code may also be stored in a permanent storage, such as hard disc drive 226 in FIG. 2, loaded in memory, such as main memory 208 in FIG. 2, and executed by a processor, such as processing unit 206 in FIG. 2.

FIG. 4 depicts process 400, which includes activities 402, 404, and 406. Activity 404 further includes tasks 408, 410, and 412. Thus, exemplary process 400 includes one or more tasks that may be included in activity 402, tasks 408, 410, and 412 included in activity 404, and one or more tasks that may be included in activity 406.

As described above, process 400 may be coded in a programming language code, such as BPEL. Such code for process 400 may include the code for various tasks that are included in the process. Illustrative embodiments provide a way to remove the complexity of modifying the process code for a process, such as process 400 in FIG. 4, whose configuration has to be changed.

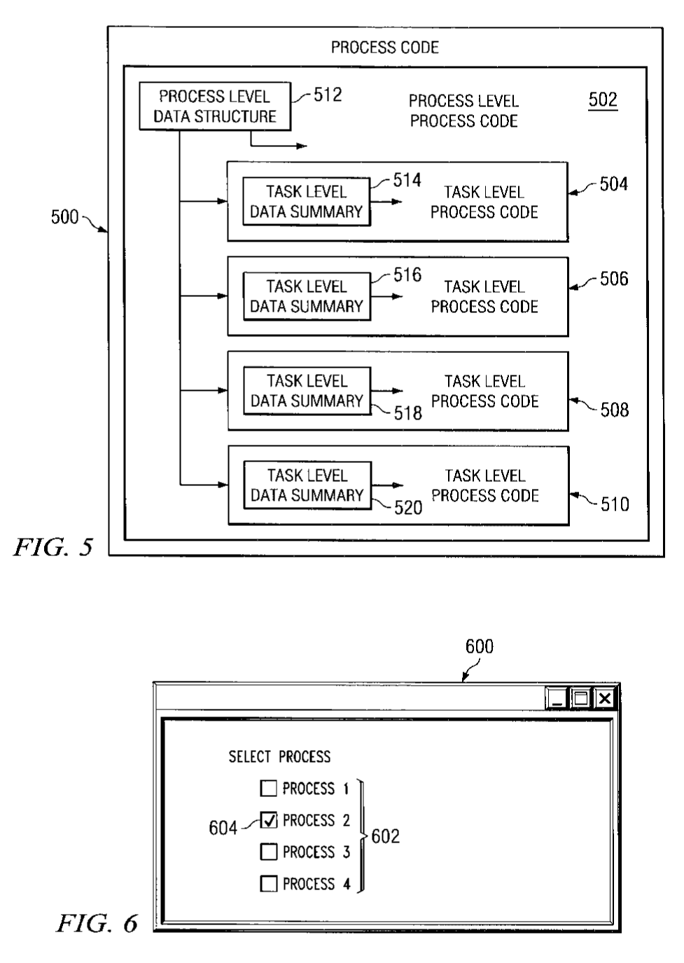

With reference now to FIG. 5, a block diagram depicting an organization of process code is shown in accordance with an illustrative embodiment. The depicted organization of a process code may be encoded in a programming language, such as BPEL, for a process, such as process 400 in FIG. 4. The process code based on the organization depicted in this figure may be implemented in a server, such as server 104 in FIG. 1. Furthermore, the process code may be a process code in the set of process codes 309 stored in database 308 in FIG. 3.

FIG. 5 shows block 500, which represents the overall process code for a process. In a typical encoding in a programming language, such as BPEL or XML, block 500 may include various headers, metadata, and other such information as needed for the integrity of the code in that programming language in addition to the code for the process itself.

Within block 500 is block 502, which represents the process code at the process level. Blocks 504, 506, 508, and 510 represent code blocks for code at the task level. In the illustration of FIG. 5, the process is shown to contain four tasks.

Block 512 represents a top-level data structure, which is shared among the various code blocks at the various levels within the process. Here, block 512 may contain data that is available not only at the process level of the process code, but also at the task level of the process code.

A task level code block may also have task level data structures for maintaining task level information. FIG. 5 shows blocks 514, 516, 518, and 520, which represent task level data structures in task level code blocks 504, 506, 508, and 510 respectively.

By providing a top-level data structure, the illustrative embodiments facilitate data sharing within the process code among the various levels of a process organization. Note that specific implementations of the illustrative embodiments may include a set of data structures at each code block level, including the process level code block and any code block at other levels within the process code. A set of data structures is one or more data structures.

With reference now to FIG. 6, a graphical user interface for process selection is depicted in accordance with an illustrative embodiment. Graphical user interface 600 is an exemplary graphical user interface that may be implemented using user interface component 306 in FIG. 3.

An implementation of the illustrative embodiments may provide a set of pre-configured process templates to select from and further configure a process. A set of pre-configured process templates is one or more pre-configured process templates. A pre-configured process template is a process pre-configured with common tasks for that kind of process.

A pre-configured process contains a pre-determined selection of tasks, configured in a pre-determined order as may be commonly used in a particular industry to which the process is applicable. Pre-configured process templates may be useful in quickly configuring a new process that is commonly used in a user's industry. For example, a user may only have to select a pre-configured process template and re-arrange tasks therein to fit the user's circumstances in order to configure a new process.

Pre-configured process templates are described here only as exemplary and are not intended to be limiting on the illustrative embodiments. Other implementations of the illustrative embodiments may allow a user to configure a process by selecting and organizing specific tasks into a custom configuration to create a process suitable for the user's circumstances.

Continuing with the description of FIG. 6, graphical user interface 600 includes collection of pre-configure process templates 602 as described above. A user may select a pre-configured process template from collection of pre-configured process templates 602 to further configure a user-specific process. FIG. 6 shows in an exemplary manner that a user has selected process 2 604.

Graphical user interface 600 may also include a list of existing processes, not shown in FIG. 6. A user may be able to select an existing process from such a list in order to reconfigure the existing process.

Depicted graphical user interface 600 is only exemplary and not limiting on the illustrative embodiments. Other graphical representations of pre-configured process templates may be used depending on the specific implementation. In addition to the pre-configured process templates, depiction of a custom process configuration may be included in a specific implementation of the illustrative embodiments.

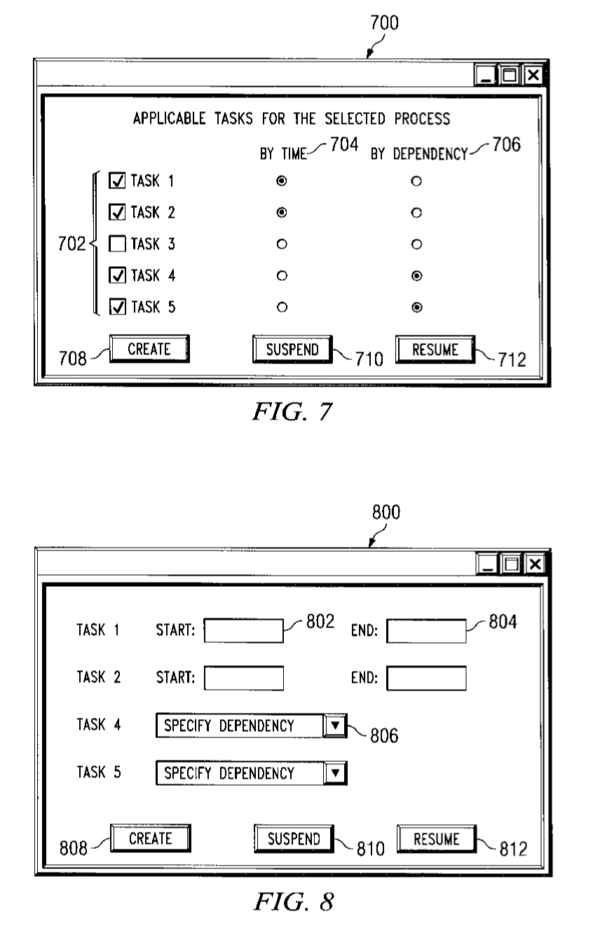

With reference now to FIG. 7, a graphical user interface for configuring tasks is depicted in accordance with an illustrative embodiment. Graphical user interface 700 is an exemplary graphical user interface that maybe implemented using user interface 306 in FIG. 3.

Graphical user interface 700 may follow the display of graphical user interface 600 in FIG. 6 where a user selects a process by selecting a pre-configured process template. Graphical user interface 700 displays list of tasks 702 that are applicable to the process selected on graphical user interface 600 in FIG. 6.

For each task in list of tasks 702, graphical user interface 700 provides two exemplary ways of configuring the task. Tasks may be configured by time 704, or by dependency 706. Generally, tasks are configurable using any task parameter. A task parameter is a criterion related to a task that can be used for configuring that task in relation to other tasks. Time is an example of a task parameter. Configuring a task by time provides a specific time for the task to run. For example, a task of approving a software build may be configured by time to finish by Mar. 1, 2007 5:00 PM Central time. Alternatively, as some more examples, a task may be configured to begin by a certain time, end by a certain time, begin exactly on a certain time, and many other possible configurations by time.

Dependency on other tasks is another example of a task parameter. A task may be configured by dependency by specifying, for example, another task on which the starting of the task depends. For example, the task of approving a build may not begin until the task of testing the build has finished. In this example, the task of approving depends on the completion of the task of testing. As another example, a task may depend on another task such that the two tasks have to be performed together. Many other dependencies can be used for specific implementations of the different embodiments.

The above time and dependency examples of task parameters are not intended to be limiting on the illustrative embodiments. Other task parameters that can be used in the illustrative embodiments are implementation specific. For example, another task parameter may be the utilization of a resource to perform the task.

Furthermore, a task may be configurable by more than one task parameter, for example, by time and dependency. For example, a user may specify that a task of approving a build may not begin until the task of testing the build has finished, but the task of approving the build must begin no later than Mar. 1, 2007 5:00 PM Central time.

A set of tasks maybe selected from list of tasks 702. A set of tasks is one or more tasks. When tasks have been selected from list of tasks 702, and the selected tasks configured by time and by dependency, the user can take further action. The configured process may be a new process being configured, in which case, the user can create the process by clicking “create” button 708. Alternatively, the user may be re-configuring an existing and possibly a running process. In that case, before the user alters the configurations of one or more tasks, the user suspends the process by clicking “suspend” button 710. Once the user is satisfied with the re-configured process, the user clicks the “resume” button 712 to resume the execution of the process.

Suspend and resume functions, with respect to a running process in the manner described above, provide the ability to re-configure a running process. For example, in a running process, a task may already have started executing when the reconfiguration is desired. By performing a suspend function, the process continues to execute the already started task but suspends the execution of future tasks not yet started until the re-configuration is completed. Upon performing the resume function, the process resumes the execution of tasks in the process according to the re-configuration.

Furthermore, the placement of the suspend and resume functions is implementation dependent. For example, these functions may be made available on graphical user interface 600 in FIG. 6, graphical user interface 700 in FIG. 7, or graphical user interface 800 in FIG. 8 in certain implementations and on other graphical user interfaces in other implementations. These functions are depicted and described with respect to graphical user interface 700 only for illustration purposes. The suspend function can also be implemented in the form of a suspending component that is capable of independent or even automatic execution. The resume function can be similarly implemented in the form of a resuming component that is capable of independent or even automatic execution.

Furthermore, the suspend, resume, and create functions are described only as exemplary. The described functions may be combined, further separated, redefined, re-labeled, expanded, or contracted in functionality depending on the specific implementations without departing from the spirit of the illustrative embodiments.

With reference now to FIG. 8, a graphical user interface for further configuring tasks is depicted in accordance with an illustrative embodiment. Graphical user interface 800 is an exemplary graphical user interface that may be implemented using user interface 306 in FIG. 3.

In an illustrative embodiment, display of graphical user interface 800 may follow the display of graphical user interface 700 in FIG. 7. Once the user has configured the tasks in graphical user interface 700 in FIG. 7, the user may further configure those tasks in graphical user interface 800. For example, a task 1 selected and configured by time on graphical user interface 700 in FIG. 7 may be further configured using time input fields 802 and 804. As another example, a task 4 selected and configured by dependency may be further configured by using input field 806 for specifying a particular dependency.

Create, suspend, and resume buttons 808, 810, and 812 respectively, provide the same functions as described with respect to create, suspend, and resume buttons 708, 710, and 712 respectively in FIG. 7. These buttons embodying these functions may be placed on a suitable graphical user interface depending on the implementation.

Other process configuration related information can be displayed together with the information depicted in FIGS. 6-8 in specific implementations of the illustrative embodiments. Furthermore, the information may be organized differently from the depiction of FIGS. 6-8 in specific implementation without departing from the spirit of the illustrative embodiment.

The graphical user interfaces depicted in FIGS. 6-8 provide a user a convenient way to configure and re-configure processes. Any underlying process code is updated by the various components depicted in FIG. 3 using the information garnered from the graphical user interfaces in FIGS. 6-8.

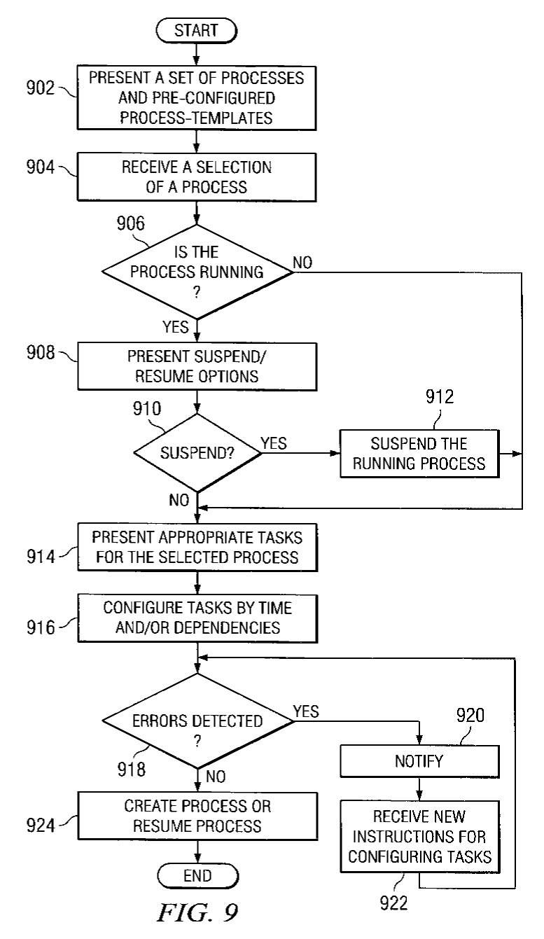

With reference now to FIG. 9, a flowchart depicting steps of configuring a process is shown in accordance with an illustrative embodiment. The process may be implemented using user interface component 306 in system 302 in FIG. 3. Depending on the specific implementation of the illustrative embodiment, the process may also be implemented in a combination of components in system 302 in FIG. 3, such as user interface component 306 and business logic component 310 in FIG. 3.

The process begins by presenting a set of pre-configured process templates and existing processes (step 902). In an alternative embodiment, this step may include presenting information for creating a custom process, together with, or in lieu of the set of pre-configured process templates.

Next, the process receives a selection of a process (step 904). Again, in an alternative embodiment, the received selection may indicate a pre-configured process template, a new custom process, or an existing process.

The process then determines if the selected process is a running process (step 906). If the selected process is running (“yes” path of step 906), the process presents suspend and resume options for the running process (step 908). The process then determines if a suspend input is received from the suspend resume options presented in step 908 (step 910). If a suspend input is received (“yes” path of step 910), the process suspends the running process (step 912). If a suspend input is not received (“no” path of step 910) the process presents a list of appropriate tasks for the selected process (step 914).

Returning to step 906, if the process determines that the selected process is not running (“no” path of step 906), the process presents a list of appropriate tasks for the selected process as well (step 914).

Next, the process configures tasks selected from the presentation of step 914 (step 916). Configuration in step 916 includes configuring the selected tasks by time and/or by dependency as described in the description of FIGS. 7 and 8.

The process then determines if an error exists in the configuration of the tasks as performed in step 916 (step 918). For example, a first task may have been configured to start after the second task, and the second task may have been configured to start after the first task, creating a circular dependency. A circular dependency created in this manner is an error because this error will prevent the first task and the second task from starting if the process is executed in this form.

If an error is detected (“yes” path of step 918), the process notifies the user configuring the process (step 920). The process then receives new instructions for configuring the tasks (step 922). The process tests again if errors exist in the configuration of the process (step 918).

If no errors are detected in the configuration (“no” path of step 918), the process proceeds to creating the configured process or resuming a reconfigured process as the case may be (step 924). The process ends thereafter.

The process in FIG. 9 is described using the depicted steps only for illustration purposes. Specific implementations of the process may combine steps, add more granular steps, or alter steps according to the implementation without departing from the spirit of the illustrative embodiments.

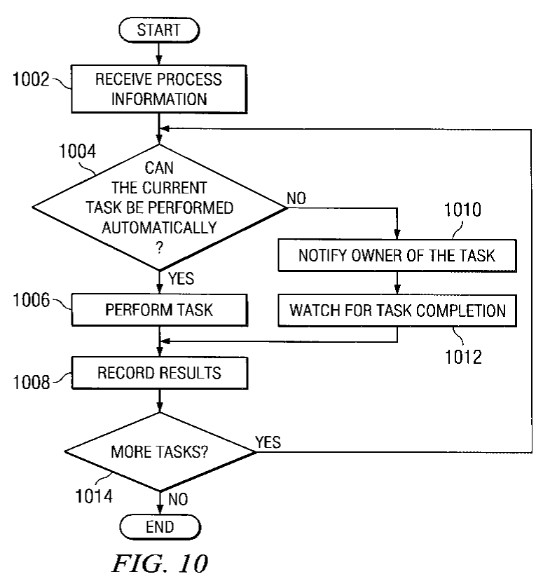

With reference now to FIG. 10, a flowchart depicting the steps of performing tasks is shown in accordance with an illustrative embodiment. The process maybe implemented using background task performance component 314 in system 302 of FIG. 3. Depending on the specific implementation of the illustrative embodiment, the process may also be implemented in a combination of components in system 302 in FIG. 3, such as background task performance component 314, notification component 316, and reporting component 318 in FIG. 3.

The process begins by receiving information about a configured process (step 1002). The process next determines if the current task in the configured process can be performed automatically (step 1004). IF the process determines that the current task can be performed automatically (“yes” path of step 1004), the process performs the task (step 1006). The process then records the results of performing the task (step 1008).

If the process determines that the current task cannot be performed automatically (“no” path of step 1004), the process notifies the owner of that task (step 1010). An owner of a task is a person who has the responsibility to perform that task.

The process then watches for the completion of the task (step 1012). Typically, the process will receive a report from the owner of the task upon the completion of the task. The process then records the results of the task (step 1008).

Next, the process determines if the configured process contains more tasks (step 1014). If the configured process contains more tasks (“yes” path of step 1014), the process returns to step 1004 and executes the subsequent steps as described above. If the process determines that no more tasks remain (“no” path of step 1014), the process ends.

Thus, the illustrative embodiments provide a computer implemented method, apparatus and computer program product to improve the process of configuration and re-configuration of processes. The illustrative embodiments provide graphical interactive manner of configuring processes without a user having to modify the process code. The illustrative embodiments modify the process code, such as BPEL code in response to the configuration inputs provided by the user using the illustrative embodiments.

The manner of configuring processes using illustrative embodiments is less cumbersome than configuring processes by modifying process code, such as BPEL code. The manner described of configuring processes in the illustrative embodiments is also more user-friendly, at least in the sense that the illustrative embodiments do not require software development skills that are otherwise needed for configuring processes using process code.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for process configuration, the computer implemented method comprising:
receiving user input through a graphical user interface, wherein the user input identifies a process for configuration;
displaying a list of tasks associated with the process in the graphical user interface;
receiving additional user input through the graphical user interface, wherein the additional user input selects a set of tasks from the list of tasks displayed in the graphical user interface;
configuring the set of tasks selected through the graphical user interface using one or more task parameters;
suspending execution of the process before configuring the set of tasks if the process is running; and
resuming execution of the process after the set of tasks are configured if the process has been suspended.

2. The computer implemented method of claim 1, wherein the process is coded in a process code, and wherein the process code is modified as a result of one or more of the user input, the additional user input, and the configuring through the graphical user interface.

3. The computer implemented method of claim 2, wherein the process code comprises:
process code for the set of tasks; and
a set of data structures, wherein the set of data structures is accessible to the process code for the set of tasks.

4. The computer implemented method of claim 1, further comprising:
validating the configuring of the set of tasks, wherein the validating uses business logic applicable to the process.

5. The computer implemented method of claim 4, wherein if the validating results in an error, the computer implemented method further comprising:
notifying about the error;
re-configuring the set of tasks; and
re-validating the re-configuring of the set of tasks.

6. The computer implemented method of claim 1, further comprising:
performing a task that is selected from the set of tasks, wherein the task that is selected is capable of being performed automatically; and
recording a result of performing the task that is selected.

7. The computer implemented method of claim 1, further comprising:
monitoring a task that is selected from the set of tasks, wherein the task that is selected is performed by a user; and
recording a result of the performing the task that is selected, wherein the recording the result occurs automatically from the monitoring.

8. A computer-usable program product comprising a computer-usable medium including computer-usable code for process configuration, the computer-usable code comprising:
computer-usable code for receiving user input through a graphical user interface, wherein the user input identifies a process for configuration;
computer-usable code for displaying a list of tasks associated with the process in the graphical user interface;
computer-usable code for receiving additional user input through the graphical user interface, wherein the additional user input selects a set of tasks from the list of tasks displayed in the graphical user interface;
computer-usable code for configuring the set of tasks selected through the graphical user interface using one or more task parameters;
computer-usable code for suspending execution of the process before configuring the set of tasks if the process is running; and
computer-usable code for resuming execution of the process after the set of tasks are configured if the process has been suspended.

9. The computer-usable program product of claim 8, wherein the process is coded in a process code, and wherein the process code is modified as a result of one or more of the user input, the additional user input, and the configuring through the graphical user interface.

10. The computer-usable program product of claim 9, wherein the process code comprises:
process code for the set of tasks; and
a set of data structures, wherein the set of data structures is accessible to the process code for the set of tasks.

11. The computer-usable program product of claim 8, further comprising:
computer-usable code for validating the configuring of the set of tasks, wherein the computer-usable code for validating uses business logic applicable to the process.

12. The computer-usable program product of claim 11, wherein if the computer-usable code for validating results in an error, the computer implemented method further comprising:
computer-usable code for notifying about the error;
computer-usable code for re-configuring the set of tasks; and
computer-usable code for re-validating the re-configuring of the set of tasks.

13. The computer-usable program product of claim 8, further comprising:
computer-usable code for performing a task that is selected from the set of tasks, wherein the task that is selected is capable of being performed automatically; and
computer-usable code for recording a result of performing the task that is selected.

14. The computer-usable program product of claim 8, further comprising:
computer-usable code for monitoring a task that is selected from the set of tasks, wherein the task that is selected is performed by a user; and
recording a result of the performing the task that is selected, wherein the recording the result occurs automatically from the monitoring.

15. A data processing system for process configuration, the data processing system comprising:
a storage device, wherein the storage device stores computer-usable program code; and
a processor, wherein the processor executes the computer-usable program code, and wherein the computer-usable program code comprises:
computer-usable code for receiving user input through a graphical user interface, wherein the user input identifies a process for configuration;
computer-usable code for displaying a list of tasks associated with the process in the graphical user interface;
computer-usable code for receiving additional user input through the graphical user interface, wherein the additional user input selects a set of tasks from the list of tasks displayed in the graphical user interface;
computer-usable code for configuring the set of tasks selected through the graphical user interface using one or more task parameters;
computer-usable code for suspending execution of the process before configuring the set of tasks if the process is running; and
computer-usable code for resuming execution of the process after the set of tasks are configured if the process has been suspended.

16. The data processing system of claim 15, wherein the process is coded in a process code, wherein the process code is modified as a result of one or more of the user input, the additional user input, and the configuring through the graphical user interface, and wherein the process code comprises:
process code for the set of tasks; and
a set of data structures, wherein the set of data structures is accessible to the process code for the set of tasks.

17. The data processing system of claim 15, further comprising:
computer-usable code for validating the configuring of the set of tasks, wherein the computer-usable code for validating uses business logic applicable to the process;
computer-usable code for notifying about an error;
computer-usable code for re-configuring the set of tasks; and
computer-usable code for re-validating the re-configuring of the set of tasks.

18. The data processing system of claim 15, further comprising:
computer-usable code for performing a task that is selected from the set of tasks, wherein the task that is selected is capable of being performed automatically;
computer-usable code for recording a result of performing the task that is selected;
computer-usable code for monitoring a second task that is selected from the set of tasks, wherein the second task that is selected is performed by a user; and
recording a second result of the performing the second task that is selected, wherein the recording the second result occurs automatically from the monitoring.

19. A system for process configuration, the system comprising:
a graphical user interface component for receiving user input, wherein the user input identifies a process for configuration, displaying a list of tasks associated with the process, receiving additional user input, wherein the additional user input selects a set of tasks from the list of tasks, and configuring the selected set of tasks using one or more task parameters;
a suspending component for suspending execution of the process before configuring the set of tasks if the process is running;
a resuming component for resuming execution of the process after the set of tasks are configured if the process has been suspended;
a database storing a process code for the process, the process code comprising process code for the set of tasks, and a set of data structures, wherein the set of data structures is accessible to the process code for the set of tasks, and wherein the process code is modified as a result of executing one or more of one or more of the user input, the additional user input, and the configuring through the graphical user interface;
a validating component for validating and re-validating the configuring of the set of tasks, wherein the computer-usable code for validating uses business logic applicable to the process; and
a notifying component for notifying about an error.

20. The system of claim 19, further comprising:
a background task performance component for performing a task that is selected from the set of tasks, wherein the task that is selected is capable of being performed automatically;
a monitoring component for monitoring a second task that is selected from the set of tasks, wherein the second task that is selected is performed by a user; and
a recording component for recording a result of performing the task that is selected, and recording a second result of performing the second task that is selected, wherein the recording the second result occurs automatically from the monitoring.
